(19) United States
(12) Patent Application Publication
(10) Pub. No.: US 2012/0292803 A1
(43) Pub. Date: Nov. 22, 2012

(54) GOLF BALL

(75) Inventor: Hiroyuki NAGASAWA, Chichibu-shi (JP)

(73) Assignee: BRIDGESTONE SPORTS CO., LTD., TOKYO (JP)

(21) Appl. No.: 13/565,362

(22) Filed: Aug. 2, 2012

Related U.S. Application Data
(62) Division of application No. 11/234,222, filed on Sep. 26, 2005.

(51) Int. Cl. B29C 45/02

(52) U.S. Cl. 264/101; 264/279

(57) ABSTRACT

In a golf ball composed of a core and one or more cover layer which encloses the core, at least one cover layer is made primarily of a thermoplastic polyurethane elastomer obtained by reaction curing a polyurethane undiluted solution which includes both a copolymeric polycarbonate polyol-containing polyol component and a polyisocyanate component. The golf ball has an improved scuff resistance, particularly an improved low-temperature scuff resistance.

### CROSS REFERENCE TO RELATED PATENT APPLICATION

The present application is a divisional of U.S. patent application Ser. No. 11/234,222, filed Sep. 26, 2005. The entire disclosure of the prior application is hereby incorporated by reference in its entirety.

### BACKGROUND OF THE INVENTION

The present invention relates to a golf ball of improved scuffing resistance, particularly low-temperature scuffing resistance, in which the cover is made using a thermoplastic polyurethane elastomer.

Golf balls having a urethane cover are widely used today not only by professional golfers and highly skilled amateurs, but also by beginners and amateur golfers of intermediate skill. Compared with the ionomers commonly used in golf ball covers, urethanes tend to confer golf balls with better spin properties, controllability and low-temperature properties. However, there remains room for improvement in the low-temperature scuff resistance of these golf balls.

Here, polyurethane materials are broadly divided, based on the process used to make molded articles, into thermoset polyurethane materials and thermoplastic polyurethane materials. Numerous golf balls which use a thermoset polyurethane material have been disclosed in the prior art, including Patent Reference 1: JP-A 2002-272878; Patent Reference 2: U.S. Pat. No. 6,686,436; and Patent Reference 3: U.S. Pat. No. 6,737,498. Patent Reference 1 describes a golf ball which uses as the cover stock a thermoset polyurethane material in which a polycarbonate polyol is employed as the polyol component. Because polycarbonate polyol has excellent heat resistance, weather resistance and water resistance, such golf balls are able to maintain their ball characteristics even under harsh conditions such as rainy weather, extreme heat and scorching sun. However, in the molding of such a thermoset polyurethane material, the heat setting step and the cooling step take a long time. Additional drawbacks include the high reactivity under heating—and thus low stability—of the starting materials, which makes the molding time difficult to control. Thermoset polyurethane materials of this type are thus regarded as having a poor productivity when used in the fabrication of specialty moldings such as golf ball covers for enclosing a core.

On the other hand, thermoplastic polyurethane materials are desirable as golf ball cover materials because they can be molded using an injection molding machine, have a short molding time, and are amenable to precision molding. Golf balls using such materials are disclosed in, for example, Patent Reference 4: U.S. Pat. No. 6,739,987 and Patent Reference 5: JP-A 2002-336380. The golf ball described in Patent Reference 4 is a ball composed of a core and a cover, wherein at least the core or cover includes a silicone-urethane copolymer which contains polycarbonate soft segments. The golf ball described in Patent Reference 5 is a golf ball composed of a core enclosed by a cover, the cover being composed primarily of a thermoplastic polyurethane material which contains a polyether polyol having an average molecular weight of at least 1500 and a polyisocyanate, and has a rebound resilience of at least 40%.

However, although the prior art such as above Patent Reference 5 describes a golf ball having both rebound resilience and scuff resistance, there remains room for improvement in the low-temperature scuff resistance. Hence, a need exists for a way to impart even better low-temperature scuff resistance to golf balls made using thermoplastic polyurethane materials which are injection moldable and provide desirable properties such as excellent ball controllability.

### SUMMARY OF THE INVENTION

The object of the invention is to provide a golf ball having improved scuff resistance, particularly low-temperature scuff resistance.

As a result of extensive investigations, I have found that a golf ball which is composed of a core enclosed by one or more cover layer and satisfies the above object can be achieved by forming at least one cover layer primarily of a thermoplastic polyurethane elastomer that is prepared using a specific polyol as the starting material.

Accordingly, the invention provides the following golf balls.

[I] A golf ball composed of a core and one or more cover layer which encloses the core, the ball being characterized in that at least one cover layer is made primarily of a thermoplastic polyurethane elastomer obtained by reaction curing a polyurethane undiluted solution containing a polyol component and a polyisocyanate component, wherein the polyol component includes a copolymeric polycarbonate polyol.
[II] The golf ball of claim [I], wherein the copolymeric polycarbonate polyol is poly(pentamethylene-co-hexamethylene carbonate)diol and/or poly(tetramethylene-co-hexamethylene carbonate)diol.
[III] The golf ball of [II], wherein the hexamethylene carbonate unit content as a proportion of the copolymeric polycarbonate polyol is 1 to 80 wt %.
[IV] The golf ball of [I], wherein the polycarbonate polyol has a number-average molecular weight of 400 to 4,000.
[V] The golf ball of [I], wherein the polycarbonate polyol accounts for at least 10 wt % of the polyol component.
[VI] The golf ball of [I], wherein the polyol component also includes polytetramethylene glycol.
[VII] The golf ball of [I], wherein the thermoplastic polyurethane elastomer has a Shore D hardness of 35 to 70.
[VIII] The golf ball of [I], wherein the thermoplastic polyurethane elastomer is prepared by a one-shot process.
[IX] The golf ball of [I], wherein the cover layer made primarily of a thermoplastic polyurethane elastomer also includes an isocyanate mixture composed of a polyisocyanate which has at least two isocyanate groups per molecule and is dispersed in a thermoplastic resin that substantially does not react with isocyanate groups.

The golf ball of the invention has an improved scuff resistance, particularly an improved low-temperature scuff resistance.

### DETAILED DESCRIPTION OF THE INVENTION

The invention is described more fully below.

The golf ball of the invention is composed of a core and one or more cover layer which encloses the core, and is characterized in that at least one cover layer is made primarily of a thermoplastic polyurethane elastomer obtained by reaction curing a polyurethane undiluted solution containing a polyol component and a polyisocyanate component, wherein the polyol component includes a copolymeric polycarbonate polyol.

Copolymeric polycarbonate polyols that may be used in the invention include those obtained by reacting two or more low-molecular-weight polyols with a carbonic acid diester of a lower alcohol (e.g., methanol). For ease of handling and to introduce onto the backbone of the resulting polycarbonate a degree of disorder that disrupts crystallinity, it is advantageous to use as the low-molecular-weight polyols a combination of two or more alkanediols having 4 to 6 carbons.

Specific examples of alkanediols having 4 to 6 carbons include 1,4-butanediol, 1,5-pentanediol, 2-methyl-1,3-propanediol, neopentyl glycol, 1,6-hexanediol, 3-methyl-1,5-pentanediol and 2-ethyl-1,3-propanediol. Of these, to ensure the golf ball has good rebound characteristics, it is preferable to use 1,4-butanediol, 1,5-pentanediol and 1,6-hexanediol.

Specific examples of the copolymeric polycarbonate polyol include poly(pentamethylene-co-hexamethylene carbonate)diol obtained using 1,5-pentanediol and 1,6-hexanediol (wherein the molar ratio of 1,5-pentanediol/1,6-hexanediol=10/90 to 90/10), and poly(tetramethylene-co-hexamethylene carbonate)diol obtained using 1,4-butanediol and 1,6-hexanediol (wherein the molar ratio of 1,4-butanediol/1,6-hexanediol=10/90 to 90/10). In the invention, the copolymeric polycarbonate polyol may be used singly or as a combination of two or more thereof.

In the practice of the invention, when a copolymeric polycarbonate polyol bearing hexamethylene carbonate units is used, the hexamethylene carbonate unit content as a proportion of the copolymeric polycarbonate polyol is generally from 1 to 80 wt %, preferably from 3 to 70 wt %, and more preferably from 5 to 60 wt %. If the hexamethylene carbonate unit content is too low, the ball may have a poor rebound. On the other hand, if this content is too high, the low-temperature scuff resistance may be poor.

In the invention, the above copolymeric polycarbonate polyol has a number-average molecular weight of generally 400 to 4,000, preferably 800 to 3,500, and more preferably 1,000 to 3,000. At too small a number-average molecular weight, the golf ball of the invention may have a poor rebound or, if the cover has a high hardness, a poor durability to impact. As used herein, the number-average molecular weight is a value determined from the hydroxyl number. The hydroxyl number is a value measured in accordance with JIS K1557.

In the practice of the invention, the method of preparing the copolymeric polycarbonate polyol is not subject to any particular limitation. For example, use can be made of the various methods described in U.S. Pat. No. 4,013,702, in U.S. Pat. No. 4,105,641, and by Schnell in Polymer Reviews 9, 9-20 (1964). It is also possible for the copolymeric polycarbonate polyol used in the invention to be a commercial product, such as a copolymeric polycarbonate diol produced by Asahi Kasei Chemicals Corporation (e.g., grades T5652 and T4692).

In addition to the above-described copolymeric polycarbonate polyol, to improve the rebound characteristics of the golf ball, the polyol component in the invention may include also other polyols. Illustrative examples of other polyols include polytetramethylene glycol (sometimes abbreviated below as “PTMG”) and poly(methyltetramethylene glycol).

The above-described copolymeric polycarbonate polyol accounts for generally 10 to 100 wt %, preferably 20 to 100 wt %, and more preferably 30 to 100 wt %, of the polyol component. If the polycarbonate polyol content of the polyol component is too low, a low-temperature property-improving effect may fail to arise.

The polyisocyanate component in the invention may be an organic polyisocyanate that has hitherto been used for preparing polyurethanes. Such organic polyisocyanates include aromatic polyisocyanates having 6 to 20 carbons (exclusive of the carbons on the isocyanate groups; the same applies below), aliphatic polyisocyanates having 2 to 18 carbons, alicyclic polyisocyanates having 4 to 15 carbons, aromatic aliphatic polyisocyanates having 8 to 15 carbons, modified forms of these polyisocyanates (e.g., carbodiimide compounds, urethane compounds and urethodione compounds), and mixtures of any two or more thereof.

Illustrative examples of the above aromatic polyisocyanates include 1,3- and/or 1,4-phenylene diisocyanate, 2,4- and/or 2,6-tolylene diisocyanate, 2,4′- and/or 4,4′-diphenylmethane diisocyanate (sometimes abbreviated below as “MDI”), 4,4′-dilsocyanatoblphenyl, 3,3′-dimethyl-4,4′-dilsocyanatoblphenyl, 3,3′-dimethyl-4,4′-diisocyanatodiphenylmethane and 1,5-naphthylene diisocyanate.

Illustrative examples of the above aliphatic polyisocyanates include ethylene diisocyanate, tetramethylene diisocyanate, hexamethylene diisocyanate, dodecamethylene diisocyanate, 2,2,4-trimethylhexamethylene diisocyanate, lysine diisocyanate, 2,6-diisocyanatomethylcaproate, bis(2-isocyanatoethyl)carbonate and 2-isocyanatoethyl-2,6-diisocyanatohexanoate.

Illustrative examples of the above alicyclic polyisocyanates include isophorone diisocyanate, dicyclohexylmethane-4,4′-diisocyanate, cyclohexylene diisocyanate, methylcyclohexylene diisocyanate and 2,5- and/or 2,6-norbornane diisocyanate.

Illustrative examples of the above aromatic aliphatic polyisocyanates include m- and/or p-xylylene diisocyanate and α,α,α′,α′-tetramethylxylylene diisocyanate.

To achieve a good balance between stability during production and the properties manifested, it is preferable for the polyisocyanate component employed in the invention to be an aromatic diisocyanate. The use of MDI is especially preferred.

A chain extender may also be included in the polyurethane undiluted solution used in the invention. Illustrative examples of such chain extenders include low-molecular-weight diols (e.g., ethylene glycol, propylene glycol, 1,3-butylene glycol, 1,4-butanediol, 1,6-hexanediol, diethylene glycol, neopentyl glycol), alicyclic diols (e.g., 1,4-bis(hydroxymethyl)cyclohexane), aromatic diols (e.g., 1,4-bis(hydroxyethyl)benzene), aliphatic diamines (e.g., ethylenediamine), alicyclic diamines (e.g., isophoronediamine), aromatic diamines 4,4′-diaminodiphenylmethane), aromatic aliphatic diamines (e.g., xylenediamine), alkanolamines (e.g., ethanolamine), hydrazine, and dihydrazides (e.g., adipic acid dihydrazide). Use can also be made of any two or more of these together. Of the above chain extenders, aliphatic diols having 2 to 12 carbons are preferred. Ethylene glycol, 1,4-butanediol, 1,6-hexanediol, or a mixture of two or more thereof, is more preferred. The chain extender has a molecular weight of preferably not more than 250.

The polyurethane undiluted solution may additionally include a shortstopper (e.g., a monoalcohol such as methanol, butanol or cyclohexanol; or a monoamine such as methylamine, butylamine or cyclohexylamine), a catalyst commonly used in polyurethane forming reactions (e.g., an amine catalyst such as triethylamine or triethylenediamine, or a tin catalyst such as dibutyltin dilaurate or dioctyltin dilaurate). Based on the polyurethane resin, the amount of catalyst used is generally not more than 1 wt %.

The thermoplastic polyurethane elastomer used in the invention is one obtained by reaction curing a polyurethane undiluted solution containing the above-described polyol component and the above-described polyisocyanate component. The method used to prepare the thermoplastic polyurethane elastomer may be a conventional method, examples of which include a one-shot process in which the components making up the polyurethane undiluted solution are all reacted at the same time; and a prepolymer process in which first the polyol component and the polyisocyanate component are reacted to form a polyurethane prepolymer, which is then reacted with a chain extender. Of these, the use of a one-shot process is preferred for ensuring that the resulting polymer has a stable quality and good productivity. The temperature conditions when the polyurethane undiluted solution is reaction cured are not subject to any particular limitation. For example, temperature conditions of 20 to 160° C., and preferably 40 to 80° C., may be used.

The thermoplastic polyurethane elastomer in the invention has a resin hardness, expressed as the Shore D hardness, of generally 35 to 70, preferably 37 to 65, and more preferably 40 to 60. If the hardness of the thermoplastic polyurethane elastomer is too low, the amount of spin by the golf ball may be excessive, lowering the carry of the ball. On the other hand, a hardness that is too high may give the ball a poor feel on impact and lower its controllability. “Shore D hardness” refers herein to the Shore D hardness value obtained in accordance with ASTM D2240.

The above thermoplastic polyurethane elastomer has a rebound resilience of generally at least 20%, preferably at least 25%, and more preferably at least 30%. Because thermoplastic polyurethane elastomers do not inherently have that good a resilience, it is desirable to scrupulously select the rebound resilience. If the cover has too low a rebound resilience, the distance traveled by the golf ball may decrease considerably. On the other hand, if the rebound resilience of the cover is too high, the initial velocity on shots of under 100 yards that require control and on putts may be too high and the feel of the ball when played may not agree with the golfer. “Rebound resilience” refers herein to the rebound resilience value obtained in accordance with JIS K7311.

At least one layer of the cover in the inventive golf ball is composed primarily of the above-described thermoplastic polyurethane elastomer. “Composed primarily of” signifies herein that the thermoplastic polyurethane elastomer accounts for at least 50 wt %, preferably at least 70 wt %, more preferably at least 90 wt %, and up to 100 wt %, of the cover layer in which it is used.

From the standpoint of, for example, adjusting the hardness of the cover layer, improving the resilience, improving the flow properties, and improving adhesion, the cover layer composed primarily of the above-described thermoplastic polyurethane elastomer may be formulated using also a thermoplastic polymer other than the thermoplastic polyurethane elastomer. Illustrative examples of such thermoplastic polymers include polyester elastomers, polyamide elastomers, ionomer resins, styrene block elastomers, polyethylenes and nylon resins.

If necessary, various additives may also be formulated in the cover layer composed primarily of the above-described thermoplastic polyurethane elastomer. For example, pigments, dispersants, antioxidants, light stabilizers, ultraviolet light absorbers and parting agents may be suitably included.

To confer the inventive golf ball with a good scuff resistance, it is advantageous to use an isocyanate mixture composed of a polyisocyanate which has at least two isocyanate groups per molecule and is dispersed in a thermoplastic resin that substantially does not react with isocyanate groups.

At least one layer of the cover of one or more layer in the inventive golf ball is made primarily of the above-described thermoplastic polyurethane elastomer. However, to efficiently achieve the objects of the invention, it is preferable for at least the outermost layer (exclusive of any surface layers formed by coating or painting) to be made primarily of the above-described thermoplastic polyurethane elastomer.

In the practice of the invention, one exemplary method that may be used to enclose the core within the cover layer involves feeding the cover stock to an injection molding machine and injecting the molten cover stock around the core. The injection molding temperature in such a case is generally in a range of 150 to 250° C. If injection molding is carried out, to suppress resin foaming during molding and also stabilize quality, it is desirable to carry out a nitrogen purge or vacuum treatment at some or all places on the resin paths from the resin feed area to the mold interior; and to carry out molding in a low-humidity environment.

The core used in the golf ball of the invention is not subject to any particular limitation. Examples of various cores that may be used include solid cores for two-piece balls, solid cores having a plurality of vulcanized rubber layers, solid cores having a plurality of resin layers, and thread-wound cores having a rubber thread layer. No particular limitation is imposed on the diameter, weight, hardness, constituent materials and other characteristics of the core.

In cases where the inventive golf ball has a construction that includes an intermediate layer, no particular limitation is imposed on the hardness, constituent materials, thickness and other characteristics of the intermediate layer. If necessary, a primer layer may be provided to improve adhesion between the intermediate layer and the cover.

It is preferable for the inventive golf ball to have a cover thickness within a range of 0.1 to 5.0 mm. The cover is not limited to a single layer, and may be formed so as to have a multilayer construction. If the cover is provided with a multilayer construction, the overall thickness of the cover may be set within the foregoing range.

The golf ball of the invention is preferably formed to a diameter and weight in accordance with the Rules of Golf, and is generally formed to a diameter of not less than 42.67 mm and a weight of not more than 45.93 g. The diameter is preferably from 42.67 to 42.9 mm. It is appropriate for deflection by the ball when subjected to a load of 980 N (100 kg) to be generally from 2.0 to 4.0 mm, and especially from 2.2 to 3.8 mm.

### EXAMPLES

The following examples of the invention and comparative examples are provided by way of illustration and not by way of limitation.

### Examples 1 to 6, Comparative Examples 1 and 2

In each example, a core material of the composition indicated below was masticated, then vulcanized and molded at 155° C. for 20 minutes to give a 38.5 mm diameter solid core for a two-piece solid golf ball. The polybutadiene rubber used was BRO1 produced by JSR Corporation. The resulting core had a specific gravity of 1.17 g/cm³, a deformation of 3.4 mm when subjected to 980 N (100 kg) of loading, and an initial velocity as measured by the USGA (R&A) method of 78.1 m/s.

Core Composition

| | | |
|---|---|---|
| Polybutadiene rubber | 100 | parts by weight |
| Zinc acrylate | 24.5 | parts by weight |
| Zinc oxide | 12 | parts by weight |
| Dicumyl peroxide | 1 | part by weight |
| Zinc pentachlorothiophenol | 1 | part by weight |

The starting materials shown in Table 1 below (units: parts by weight) were intimately mixed in a twin-screw extruder at a mixing temperature of 190 to 220° C. to form a cover stock. The solid core described above was placed within an injection-molding mold and the cover stock was injection-molded around the core, thereby giving a two-piece golf ball having a 2.1 mm thick cover. The golf balls thus obtained in the respective examples of the invention and comparative examples were left to stand at room temperature for one week, following which the ball properties were evaluated. The results are shown in Table 1.

TABLE 1

| | | | | | | | | | Comparative | |
|---|---|---|---|---|---|---|---|---|---|---|
| | | | Example | | | | | | Example | |
| (parts by weight) | | | 1 | 2 | 3 | 4 | 5 | 6 | 1 | 2 |
| Thermoplastic | Polyurethane 1 | | 100 | | | | | | | |
| polyurethane | Polyurethane 2 | | | 100 | | | | | | |
| | Polyurethane 3 | | | | 100 | | | | | |
| | Polyurethane 4 | | | | | 100 | | | | |
| | Polyurethane 5 | | | | | | 100 | | | |
| | Polyurethane 6 | | | | | | | 100 | | |
| | Polyurethane 7 | | | | | | | | 50 | 50 |
| | Polyurethane 8 | | | | | | | | 50 | 50 |
| Titanium oxide | | | 3 | 3 | 3 | 3 | 3 | 3 | 3 | 3 |
| Polyethylene wax | | | 1 | 1 | 1 | 1 | 1 | 1 | 1 | 1 |
| Isocyanate mixture | | | 20 | 20 | 20 | 20 | 20 | 20 | 20 | |
| Ball | Diameter (mm) | | 42.73 | 42.75 | 42.75 | 42.74 | 42.70 | 42.70 | 42.73 | 42.70 |
| properties | Weight (g) | | 46.15 | 46.27 | 46.39 | 46.43 | 45.92 | 45.79 | 45.65 | 45.70 |
| | Hardness (mm) | | 2.91 | 2.94 | 2.91 | 2.94 | 2.82 | 2.80 | 2.86 | 2.90 |
| | Initial velocity (m/s) | | 76.08 | 76.06 | 76.02 | 75.92 | 76.58 | 76.76 | 76.80 | 76.69 |
| | Scuff | 23° C. | 3 | 3 | 4 | 4 | 3 | 3 | 3 | 2 |
| | resistance | 13° C. | 3 | 3 | 4 | 4 | 3 | 3 | 3 | 2 |
| | | 0° C. | 4 | 4 | 5 | 5 | 3 | 3 | 2 | 1 |

### Polyurethane 1

An MDI-copolymeric polycarbonate diol polyurethane having a Shore D hardness of 53 and a rebound resilience of 29%. The copolymeric polycarbonate diol included in this copolymer was T5652 produced by Asahi Kasei Chemicals Corporation and had a number-average molecular weight of 2,000. T5652 is poly(pentamethylene-co-hexamethylene carbonate)diol in which 1,5-pentanediol/1,6-hexanediol (molar ratio)=50/50. The same applies below.

### Polyurethane 2

An MDI-copolymeric polycarbonate diol polyurethane having a Shore D hardness of 47 and a rebound resilience of 29%. The copolymeric polycarbonate diol included in this copolymer was T5652 produced by Asahi Kasei Chemicals Corporation and had a number-average molecular weight of 2,000.

### Polyurethane 3

An MDI-copolymeric polycarbonate diol polyurethane having a Shore D hardness of 53 and a rebound resilience of 25%. The copolymeric polycarbonate diol included in this copolymer was T4692 produced by Asahi Kasei Chemicals Corporation and had a number-average molecular weight of 2,000. T4692 is poly(tetramethylene-co-hexamethylene carbonate)diol in which 1,4-butanediol/1,6-hexanediol (molar ratio)=90/10. The same applies below.

### Polyurethane 4

An MDI-copolymeric polycarbonate diol polyurethane having a Shore D hardness of 47 and a rebound resilience of 25%. The copolymeric polycarbonate diol included in this copolymer was T4692 produced by Asahi Kasei Chemicals Corporation and had a number-average molecular weight of 2,000.

### Polyurethane 5

An MDI-copolymeric polycarbonate diol/PTMG polyurethane having a Shore D hardness of 54 and a rebound resilience of 38%. The copolymeric polycarbonate diol included in this copolymer was T4692 produced by Asahi Kasei Chemicals Corporation and had a number-average molecular weight of 2,000. The polyol component used was the mixture T4692/PTMG (weight ratio)=50/50.

### Polyurethane 6

An MDI-copolymeric polycarbonate diol/PTMG polyurethane having a Shore D hardness of 54 and a rebound resilience of 46%. The copolymeric polycarbonate diol included in this copolymer was T4692 produced by Asahi Kasei Chemicals Corporation and had a number-average molecular weight of 2,000. The polyol component used was the mixture T4692/PTMG (weight ratio)=30/70.

### Polyurethane 7

An MDI-PTMG polyurethane produced by DIC Bayer Polymer, Ltd. under the brand name Pandex T8295. JIS-A hardness, 97. Rebound resilience, 44%.

### Polyurethane 8

An MDI-PTMG polyurethane produced by DIC Bayer Polymer, Ltd. under the brand name Pandex T8260. Durometer D hardness, 56. Rebound resilience, 46%.

### Polyethylene Wax

Sanwax 161P (produced by Sanyo Chemical Industries, Ltd.).

### Isocyanate Mixture

Crossnate EM30, an isocyanate master batch which is produced by Dainichi Seika Colour & Chemicals Mfg. Co., Ltd., contains 30% of 4,4′-diphenylmethane diisocyanate (concentration of amine reverse-titrated isocyanate according to JIS-K1556, 5 to 10%), and in which the base resin is a polyester elastomer.

### Hardness (mm)

The deformation when subjected to a load of 980 N (100 kg) was measured.

Initial Velocity (m/s)

Determined in accordance with the USGA (R&A) measurement method.

### Scuff Resistance

The ball was held at respective temperatures of 23° C., 13° C. and 0° C. Using a swing robot machine, each ball was hit with a pitching wedge as the club at a head speed of 33 m/s, after which damage from the impact was visually rated according to the following criteria.
5: No damage at all or substantially free of apparent damage.
4: Slight damage observed, but of a substantially negligible degree.
3: Surface somewhat frayed.
2: Surface frayed and portions of dimples missing.
1: Some dimples completely obliterated.

1. A method of making a golf ball comprising the steps of:
carrying out a nitrogen purge or vacuum treatment on a resin path from a resin feed area to a mold interior in an injection molding apparatus; followed by
enclosing a core within one or more cover layers by injection molding a molten cover stock containing a thermoplastic polyurethane elastomer around the core at a temperature of from 150° C. to 250° C. in the injection molding apparatus, wherein the molten cover stock forms at least one cover layer;
wherein the thermoplastic polyurethane elastomer is prepared by a one-shot process and contains a polyol component and a polyisocyanate component, wherein the polyol component includes poly(tetramethylene-co-hexamethylene carbonate)diol in which the hexamethylene carbonate unit content of the copolymeric polycarbonate polyol is 10 to 50 mol %;
wherein the at least one cover layer also includes an isocyanate mixture composed of a polyisocyanate which has at least two isocyanate groups per molecule and is dispersed in a thermoplastic resin that does not react with isocyanate groups.

2. A method of making a golf ball comprising the steps of:
preparing a thermoplastic polyurethane elastomer by a one-shot process;
carrying out a nitrogen purge or vacuum treatment on a resin path from a resin feed area to a mold interior in an injection molding apparatus; followed by
enclosing a core within one or more cover layers by injection molding a molten cover stock containing the thermoplastic polyurethane elastomer around the core at a temperature of from 150° C. to 250° C. in the injection molding apparatus, wherein the molten cover stock forms at least one cover layer;
wherein the thermoplastic polyurethane elastomer contains a polyol component and a polyisocyanate component, wherein the polyol component includes poly(tetramethylene-co-hexamethylene carbonate)diol in which the hexamethylene carbonate unit content of the copolymeric polycarbonate polyol is 10 to 50 mol %;
wherein the at least one cover layer also includes an isocyanate mixture composed of a polyisocyanate which has at least two isocyanate groups per molecule and is dispersed in a thermoplastic resin that does not react with isocyanate groups.

3. The method of making a golf ball of claim 1, wherein the copolymeric polycarbonate polyol has a number-average molecular weight of 400 to 4,000.

4. The method of making a golf ball of claim 1, wherein the copolymeric polycarbonate polyol accounts for at least 10 wt % of the polyol component.

5. The method of making a golf ball of claim 1, wherein the polyol component also includes polytetramethylene glycol.

6. The method of making a golf ball of claim 1, wherein the thermoplastic polyurethane elastomer has a Shore D hardness of 35 to 70.

7. The method of making a golf ball of claim 1, wherein the thermoplastic polyurethane elastomer accounts for at least 50 wt % of the cover layer.

8. The method of making a golf ball of claim 1, wherein the cover thickness is within a range of 0.1 to 5.0 mm.

9. The method of making a golf ball of claim 2, wherein the copolymeric polycarbonate polyol has a number-average molecular weight of 400 to 4,000.

10. The method of making a golf ball of claim 2, wherein the copolymeric polycarbonate polyol accounts for at least 10 wt % of the polyol component.

11. The method of making a golf ball of claim 2, wherein the polyol component also includes polytetramethylene glycol.

12. The method of making a golf ball of claim 2, wherein the thermoplastic polyurethane elastomer has a Shore D hardness of 35 to 70.

13. The method of making a golf ball of claim 2, wherein the thermoplastic polyurethane elastomer accounts for at least 50 wt % of the cover layer.

14. The method of making a golf ball of claim 2, wherein the cover thickness is within a range of 0.1 to 5.0 mm.
